(19) United States
(12) Patent Application Publication
(10) Pub. No.: US 2016/0171763 A1
(43) Pub. Date: Jun. 16, 2016

(54) METHOD AND APPARATUS OF GENERATING A 3D MODEL FROM AN OBJECT

(71) Applicants: INVENTEC APPLIANCES (PUDONG) CORPORATION, Shanghai (CN); INVENTEC APPLIANCES CORP., New Taipei City (TW); INVENTEC APPLIANCES (SHANGHAI) CO. LTD., Shanghai (CN)

(72) Inventors: Ye-Lin ZHOU, Shanghai (CN); Shih-Kuang TSAI, Shanghai (CN)

(21) Appl. No.: 14/849,279

(22) Filed: Sep. 9, 2015

(30) Foreign Application Priority Data
Dec. 12, 2014 (CN) 201410767330.3

(51) Int. Cl. G06T 17/20; H04N 7/18; H04N 5/225

(52) U.S. Cl. CPC G06T 17/20; H04N 5/225; H04N 7/183

(57) ABSTRACT

A method of generating a 3D model from an object comprises: gathering a plurality of images of an object, and the object distance is modified to generate different images; computing the sharpness of each pixel of each image; defining each of the images being on a plane, and each of the planes corresponds to a 2D space which also corresponds to a Z-axial value; comparing the sharpness of points with the same 2D coordinate of all the planes, and picking up the plane with the most sharpness point, and then combining the 2D coordinate and the Z-axial value of the picked plane, to get a 3D coordinate; repeating the last process to get a plurality of 3D coordinate; gathering a 3D model according to the 3D coordinate. This invention is able to be achieved with the prior imaging device and the whole process of gathering a 3D model is simplified.

### FIELD OF THE INVENTION

The present invention relates image processing techniques, particularly, relates to a method and apparatus for generating 3D model of an object.

### BACKGROUND OF THE INVENTION

In some situations, it is necessary to generate a non-contact three-dimensional (3D) model of an object, for example, the applications in 3D printer techniques. So far, one of the main methods of generating 3D model of an object is: multiple images of a target object are captured from different view angles by a specific imaging apparatus, and then these images from the different view angles are analyzed to generate a 3D model of the target object.

The present methods have some drawbacks, for example, 3D models require use of the specific imaging apparatus rather than regular ones. Consequently, it is difficult to build 3D models for objects because the specific imaging apparatus to build 3D models can only be used in certain environments.

### SUMMARY OF THE INVENTION

Apparatus for generating 3D models of an object is provided herein, which can cooperate with typical imaging apparatus to implement the generation of 3D models so as to make gathering of 3D models simple.

According to one aspect of the present invention, the present invention provides a method for generating a three-dimensional model of an object, which comprises the steps: obtaining a plurality of two-dimensional image of the object at different object distance with an imaging apparatus, in which each image includes a plurality of pixels; assigning a third dimension coordinate (z) to each image, the third dimension coordinate (z) corresponding to the respective object distance; assigning two-dimensional coordinate (x, y) to each pixel; computing a sharpness valve for each pixel; for each two-dimensional coordinate (x, y), comparing the pixel sharpness value across all the images and selecting the image with the highest sharpness value; generating a plurality of three-dimensional coordinate (x, y, z) by combining each two-dimensional coordinate (x, y) with the third dimension coordinate (z) of the selected image; and generating the three-dimension model according to the plurality of three-dimensional coordinate (x, y, z).

The present invention also provides an apparatus for generating a three-dimensional model of an object. The apparatus includes: an imaging unit configured to obtain a plurality of two-dimensional images of the object at different object distances, in which the images includes a plurality of pixels; a computing unit configured to assign two-dimensional coordinate (x, y) to each pixel and a third dimension coordinate (z) to each image corresponding to the respective object distance, the computing unit further configured to compute a sharpness value for each pixel and compare the pixel sharpness values of each two-dimensional coordinate (x, y) across all the images to select the image with the highest sharpness value, the computing unit being also configured to generate a plurality of three-dimensional coordinate (x, y, z) by combining each two-dimensional coordinate (x, y) with the third dimension coordinate (z) of the selected image, and the computing unit further configured to the generate the three-dimensional model according to the plurality of three-dimensional coordinate (x, y, z); and a storage unit configured to store the image and the three-dimensional model.

### BRIEF DESCRIPTION OF THE DRAWINGS

FIG. 1 is a flow chart illustrating a method for generating a 3D model of an object according an embodiment of the present invention.

FIG. 2 is a flow chart illustrating a method for generating a 3D model of an object according to an embodiment of the present invention.

FIG. 3 is a schematic diagram illustrating n^{th} images to be gathered according to an embodiment of the present invention.

FIG. 4 is a schematic diagram illustrating a 3D model to be generated according to an embodiment of the present invention.

FIG. 5 is a diagram illustrating an apparatus for generating a 3D model of an object according to an embodiment of the present invention.

### DETAILED DESCRIPTION OF THE PREFERRED EMBODIMENT

Advantages and features of the invention will become more apparent with reference to the following detailed description of presently preferred embodiments thereof in connection with the accompany drawings.

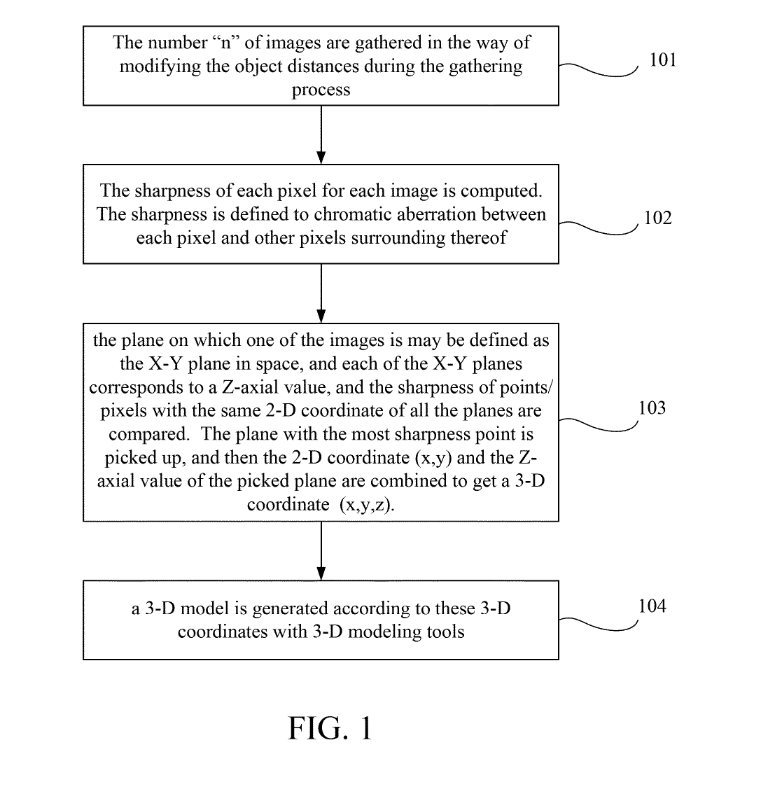

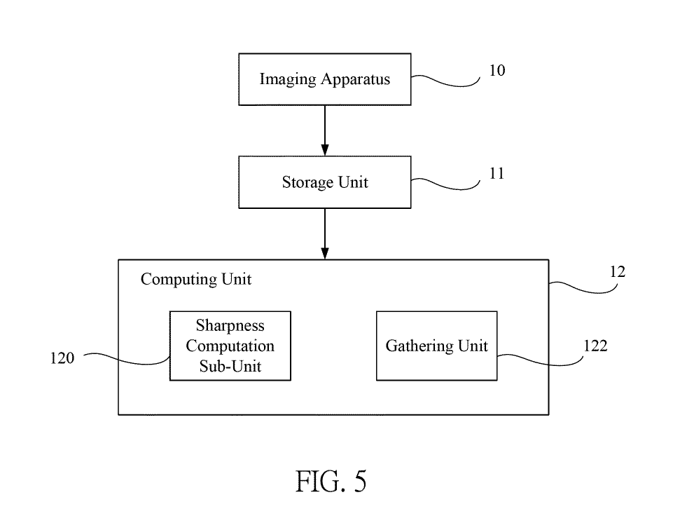

Referring to FIG. 1, step 101: images of an object are gathered by an imaging apparatus 10 shown in FIG. 5, and “n” number of images of the object are gathered at different object distances during the gathering process. That is, the first image is gathered at the first object distance, and the second image is gathered at the second object distance, and the process is repeated “n” times (“n” being a natural number). The larger the number “n”, the more images are taken, and the more precise the final 3D model is. Object distances may be determined in various ways. For example, object distance may be a multiple of a unit of focus, and be increased or decreased in degrees of the unit of focus. That is, “n” number of images with “n” number of focuses are taken with the imaging apparatus. Alternatively, the object distance between the object and the imaging apparatus may be increased or decreased progressively by a preset unit distance to gather “n” number of images with the “n” number of object distances.

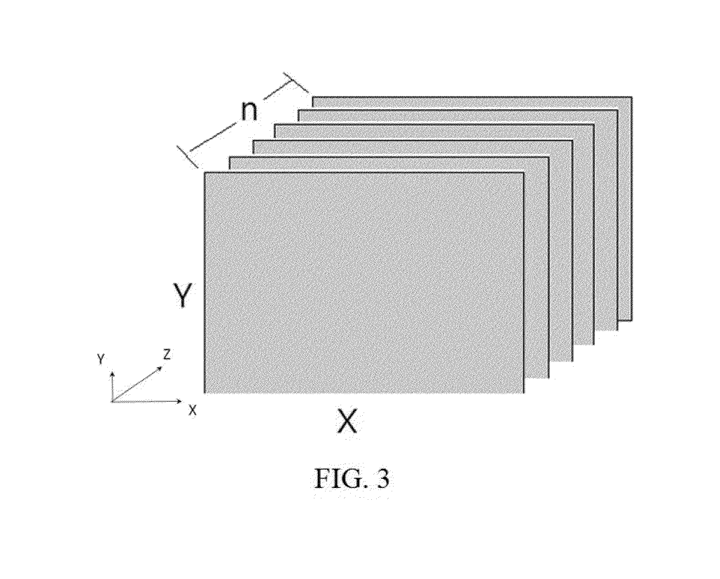

Step 102: the sharpness of each pixel for each image is computed. The sharpness value is defined as the chromatic aberration between each pixel and other pixels surrounding thereof Each image taken by the imaging apparatus is a 2D image on a plane in a spatial coordinate system (x, y). The various image planes are parallel to each other along a depth spatial coordinate (z). Thus, each image plane may be defined as a X-Y plane and the corresponding plane depth coordinate is Z=1, 2, 3, . . . , n. See FIG. 3 for further clarifications. Consequently, n^{th} image is on the plane that the equation is Z=n.

The position of each pixel for each image on the corresponding plane may be described with a two-dimensional coordinate (x, y). The sharpness value of each pixel for each image can be determined by the sharpness of one or more colors. For example, the sharpness of each pixel may be computed using an equation for tricolor sharpness:

Pixel(x, y, n)=aR*(PixelR(x, y, n))+aG*(PixelG(x, y, n))+aB*(PixelB(x, y, n)),

where Pixel(x, y, n) is the sharpness value of one current pixel at the position (x, y) for the n^{th} image at Z axis; PixelR(x, y, n) is the red aberration between the current pixel and others surrounding thereof; PixelG(x, y, n) is the green aberration between the current pixel and others surrounding thereof; PixelB(x, y, n) is the blue aberration between the current pixel and others surrounding thereof; aR is a red weight parameter; aG is a green weight parameter; and aB is a blue weight parameter. It is noted that aR, aG, and aB can be dynamically modulated according to practical applications. Furthermore, PixelR(x, y, n) may be acquired with the equation as follow:

PixelR(x, y, n)=abs(R(x, y, n)−R(x−1, y, n))+abs(R(x, y, n)−R(x, y−1, n))+abs(R(x, y, n)−R(x+1, y, n))+abs(R(x, y, n)−R(x, y+1, n)),

where abs is absolute value sign; R(x, y, n) is the red value of current pixel at the position (x, y) for n^{th} image at Z axis; R(x−1, y, n) is the red value of current pixel at the position (x−1, y) for n^{th} image at Z axis; R(x, y−1, n) is the red value of current pixel at the position (x, y−1) for n^{th} image at Z axis; R(x+1, y, n) is the red value of current pixel at the position (x+1, y) for n^{th} image at Z axis; R(x, y+1, n) is the red value of current pixel at the position (x, y+1) for the n^{th} image at Z axis. The same scheme may be used for the calculation of PixelG and PixelB and are not repeated here.

Step 103: the plane on which an image is taken may be defined as the X-Y plane in space, and the depth location of each of the X-Y planes corresponds to a Z-axial value. The sharpness of points/pixels with the same 2D coordinate of all the planes are compared and the image plane with the most sharpness point is selected. The 2D coordinate (x, y) and the Z-axial value of the chosen planes are combined to get a 3D coordinate (x, y, z). In practice, a 2D coordinate (x₁, y₁) can correspond to each Z-axial value Z=1, 2, . . . , n to get a plurality of points (x₁, y₁, 1), (xᵢ, yᵢ, 2) . . . , (x₁, y₁, n). The point at the plane Z=z₁ has the most sharpness so as to get a 3D coordinate (x₁, y₁, z₁). The aforementioned process is repeated to allocate each 2D coordinate (x, y) to a corresponding Z-axial value, which results in a plurality of 3D coordinates.

Step 104: a 3D model is generated with 3D modeling tools according to these 3D coordinate.

According to an embodiment, the images of the object are gathered and in the gathering process, the object distance is modified to generate “n” number of 2D images. The sharpness of each pixel for each image is computed. Each of the 2D images taken corresponds to a plane and each plane corresponds to a 2D space X-Y axis and has a Z-axial (depth) value assigned according to its depth “n”. Taking an X-Y coordinate and finding the corresponding point/pixel on all the image planes, the sharpness of the point/pixel of the image is compared. From the comparison, the plane with the most sharpness point is selected and together with its Z-axial depth value, a 3D coordinate (x, y, z) is generated. This process is repeated for all the X-Y coordinate to get a plurality of 3D coordinate (xₙ, yₙ, zₙ). Using this information, a 3D model is generated according to the 3D coordinate gathered. This method gathers images of the object by modifying the object distances, instead of needing to gather images by changing to different view angles. Since it is not necessary to gather images with different view angles, such method can be implemented with a regular imaging apparatus. Using the computed 3D coordinate of the object, a 3D model can be generated. Consequently, the method of the present invention makes gathering or generating a 3D model from an object simpler and broadens application fields.

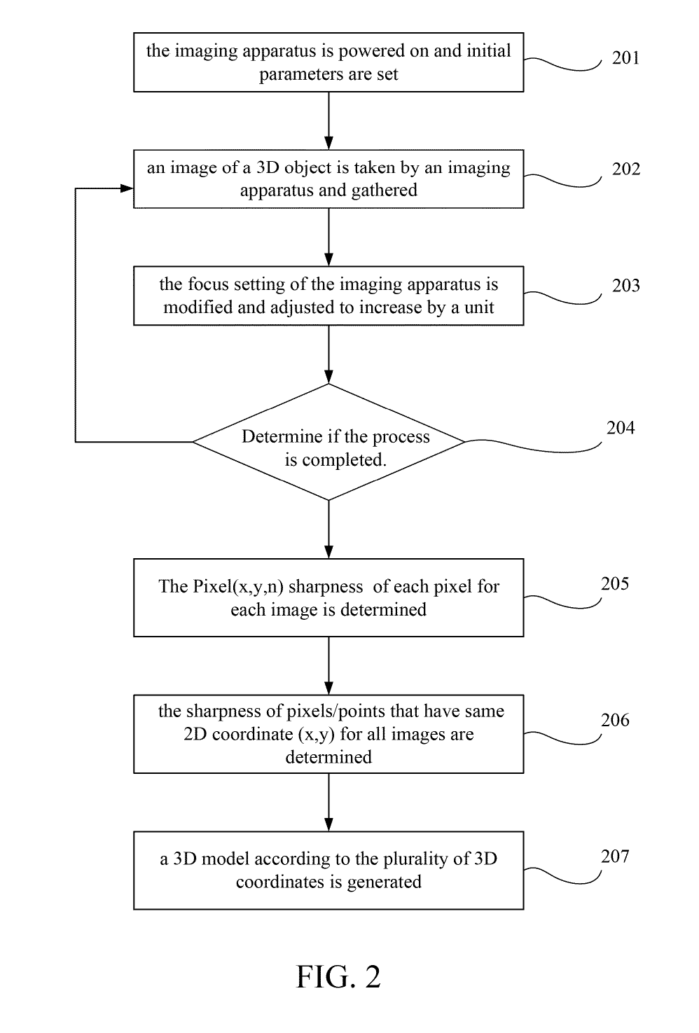

Referring to FIG. 2, an embodiment is described below which includes the steps:

Step 201: the imaging apparatus is powered on and initial parameters are set. These initial parameters include: aperture is 2.8 and focus 0.7 m.

Step 202: an image of a 3D object is taken by an imaging apparatus and gathered.

Step 203: the focus setting of the imaging apparatus is modified and adjusted to increase by a unit.

Step 204: Determine if the process is completed. If it is completed, go to step 205. Otherwise, go back to step 202 and repeat the image gathering step. As shown in FIG. 3, the gathered “n” number of images are distributed on Z-axis direction. The plane on which one of images is can be viewed as an X-Y plane, and each X-Y plane has a corresponding a Z-axis depth value.

Step 205: the Pixel(x, y, n) sharpness of each pixel for each image is determined by the following equation:

Pixel(x, y, n)=aR*(PixelR(x, y, n))+aG*(PixelG(x, y, n))+aB*(PixelB(x, y, n)),

where Pixel(x, y, n) is the sharpness of the pixel at position (x, y) for the nth image on the Z axis; PixelR(x, y, n) is the red aberration between the pixel and others surrounding thereof; PixelG(x, y, n) is the green aberration between the pixel and others surrounding thereof; PixelB(x, y, n) is the blue aberration between the pixel and others surrounding thereof; aR is a red weight parameter; aG is a green weight parameter; and aB is a blue weight parameter.

PixelR(x, y, n)=abs(R(x, y, n)−R(x−1, y, n))+abs(R(x, y, n)−R(x, y−1, n))+abs(R(x, y, n)−R(x+1, y, n))+abs(R(x, y, n)−R(x, y+1, n)),

where abs is absolute value sign; R(x, y, n) is the red value of one pixel at position (x, y) for n^{th} image on the Z axis; R(x−1, y, n) is the red value of the pixel at position (x−1, y) for n^{th} image on the Z axis; R(x, y−1, n) is the red value of one pixel at position (x, y−1) for n^{th} image on the Z axis; R(x+1, y, n) is the red value of one pixel at position (x+1, y) for n^{th} image on the Z axis; R(x, y+1, n) is the red value of one pixel at position (x, y+1) for n^{th} image on the Z axis. The same calculation is used for PixelG and PixelB and is not further repeated here.

Alternatively, an ambiguity value of each pixel can be computed. That is, the more ambiguous the pixel image is, the less its sharpness value is. If ambiguity is calculated rather than sharpness, the pixel with the least ambiguity value is picked up to acquire its corresponding Z-axial value.

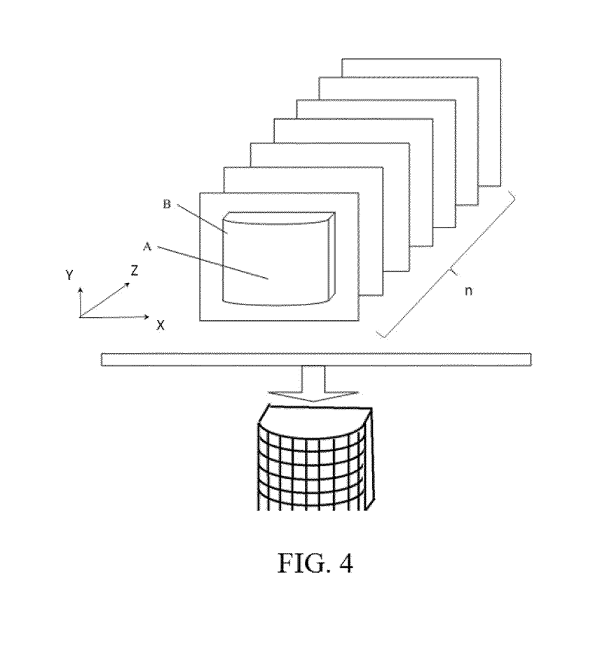

Step 206: the sharpness of pixels/points that have the same 2D coordinate (x, y) for all images are determined. The pixel with the most sharpness is selected and has a corresponding Z-axial value, wherein the corresponding Z-axial value can be represented as Z(x, y)=Max(Pixel(x, y, 1), Pixel(x, y, 2) . . . , Pixel(x, y, n)). Then the 2D coordinate (x, y) and Z(x, y) are combined to obtain 3D coordinate (x, y, Z(x, y)). For example, referring to an embodiment shown in FIG. 4, there are same X-axial and Y-axial values of points “A” and “B” on different X-Y planes. The Z-axial value of point “A” is represented as Z(x, y)=1, and the Z-axial value of point “B” is represented as Z(x, y)=5, and the same is obtained for all pixels.

Step 207: a 3D model according to the plurality of 3D coordinates is generated.

Utilizing a set of different images taken with various change of focuses, sharpness values of multiple consecutive target images are analyzed to create a 3D projection model. The 3D projection model can be applied to facial modeling and other similar fields. If additional imaging apparatus is available for use, a whole 3D model of an object with more details can be generated by computing 3D projection models from different viewing angles. In practice, a high precision imaging apparatus may be equipped with a micrometer, and consecutive images are gathered along with shifting displacements of the micrometer. Thus, a high-precision 3D model is gathered or generated for the object. Alternatively, a microscopic imaging apparatus may be used for gathering a 3D model of a microscopic object.

Referring to FIG. 5, according to an embodiment of the present invention, an equipment 1 for gathering 3D model includes an imaging apparatus 10, a storage unit 11 and a computing unit 12. The imaging apparatus 10 gathers “n” number of images of a target object by changing object distances, and outputs these images to the storage unit 11 to store the image information. The computing unit 12 computes the sharpness value of each pixel for each image. The sharpness is a chromatic aberration between a current pixel and surrounding pixels. That imaging plane may be defined as a transverse-coordinate plane, and a longitudinal coordinate is orthogonal to the transverse-coordinate plane. The sharpness of the pixels that have the same 2D coordinate (x, y) are compared across all the images to acquire a longitudinal axis value corresponding to the image having the pixel with the most sharpness. The transverse coordinates are combined with the longitudinal axis value to get 3D coordinate. A 3D model according to the 3D coordinate can be gathered.

The imaging apparatus may be a typical or regular equipment, for example, the imaging apparatus in practice may include an imaging optical apparatus, optical-sensitive apparatus (charge coupled device (CCD) or complementary metal-oxide-semiconductor (CMOS)), or other control module capable of controlling different objective distances for an imaging optical apparatus.

Preferably, the imaging apparatus 10 gathers the number “n” of images with increasing or decreasing in degrees of a unit of focus each time, and alternatively, the number “n” of images are gathered by increasing or decreasing various units of distance between the imaging apparatus and the target object.

Preferably, the computing unit 12 includes a sharpness computation sub-unit 120. Each pixel on X-Y coordinate plane can be represented as a 2D coordinate (x, y). The sharpness of each pixel may be computed with the equation:

Pixel(x, y, n)=aR*(PixelR(x, y, n))+aG*(PixelG(x, y, n))+aB*(PixelB(x, y, n)),

where Pixel(x, y, n) is the sharpness of one current pixel at position (x, y) for the nth image at Z axis; PixelR(x, y, n) is the red aberration between the current pixel and others surrounding thereof; PixelG(x, y, n) is the green aberration between the current pixel and others surrounding thereof; PixelB(x, y, n) is the blue aberration between the current pixel and others surrounding thereof; aR is a red weight parameter; aG is a green weight parameter; and aB is a blue weight parameter.

Preferably, the sharpness computation sub-unit 120 acquires PixelR(x, y, n) by utilizing the equation as follow:

PixelR(x, y, n)=abs(R(x, y, n)−R(x−1, y, n))+abs(R(x, y, n)−R(x, y−1, n))+abs(R(x, y, n)−R(x+1, y, n))+abs(R(x, y, n)−R(x, y+1, n)),

where abs is absolute value sign; R(x, y, n) is the red value of one current pixel at position (x, y) for the n^{th} image at Z axis; R(x−1, y, n) is the red value of the current pixel at position (x−1, y) for the nth image at Z axis; R(x, y−1, n) is the red value of the current pixel at position (x, y−1) for the nth image at Z axis; R(x+1, y, n) is the red value of the current pixel at position (x+1, y) for the nth image at Z axis; R(x, y+1, n) is the red value of the current pixel at position (x, y+1) for the n^{th} image at Z axis.

Preferably, the computing unit 12 further includes a gathering unit 122 of 3D coordinate. Each pixel on X-Y coordinate plane can be represented as a 2D coordinate (x, y) and corresponds to a Z-axial value to represent as Z(x, y). The sharpness of pixels that have same 2D coordinate (x, y) for all images are determined. The pixel with the most sharpness is selected to work out its corresponding Z-axial value, wherein the corresponding Z-axial value can be represented as Z(x, y)=Max(Pixel(x, y, 1), Pixel(x, y, 2) . . . Pixel(x, y, n)). Then the 2D coordinate (x, y) and Z-axial value Z(x, y) are combined to get 3D coordinate (x, y, Z(x, y)). Using the 3D coordinate, the apparatus generates a 3D model of the target object.

While the invention has been described in terms of what is presently considered to be the most practical and preferred embodiments, it is to be understood that the invention needs not be limited to the disclosed embodiments. It is intended to cover various modifications and similar arrangements included within the spirit and scope of the appended claims which are to be accorded with the broadest interpretation so as to encompass all such modifications and similar structures.

What is claimed is:

1. A method for generating a three-dimensional model of an object comprising:
obtaining, with an imaging apparatus, a plurality of two-dimensional images of the object at different object distances, wherein each image comprises a plurality of pixels;
assigning a third dimension coordinate (z) to each image, the third dimension coordinate (z) corresponding to the respective object distance;
assigning two-dimensional coordinate (x, y) to each pixel;
computing a sharpness value for each pixel;
for each two-dimensional coordinate (x, y), comparing the pixel sharpness value across all the images and selecting the image with the highest sharpness value;
generating a plurality of three-dimensional coordinate (x, y, z) by combining each two-dimensional coordinate (x, y) with the third dimension coordinate (z) of the selected image; and
generating the three-dimension model according to the plurality of three-dimensional coordinate (x, y, z).

2. The method of claim 1, wherein the imaging apparatus modifies the object distance by:
increasing or decreasing the object distance by a multiple of a unit of focus; or increasing or decreasing the object distance by predetermined distance units between the imaging apparatus and the object.

3. The method of claim 1, wherein the sharpness value of each pixel is computed using an equation as follows:
Pixel(x, y, n)=aR*(PixelR(x, y, n))+aG*(PixelG(x, y, n))+aB*(PixelB(x, y, n)),
wherein Pixel(x, y, n) is the sharpness of the pixels at position (x, y) for the n^{th} image of coordinate (z); PixelR(x, y, n) is a red aberration between the pixel and other surrounding pixels; PixelG(x, y, n) is a green aberration between the pixel and other surrounding pixels; PixelB(x, y, n) is a blue aberration between the pixel and other surrounding pixels; aR is a red weight parameter; aG is a green weight parameter; and aB is a blue weight parameter.

4. The method of claim 3, wherein the PixelR(x, y, n) is acquired using an equation as follow:
PixelR(x, y, n)=abs(R(x, y, n)−R(x−1, y, n))+abs(R(x, y, n)−R(x, y−1, n))+abs(R(x, y, n)−R(x+1, y, n))+abs(R(x, y, n)−R(x, y+1, n)),
wherein abs is an absolute value sign; R(x, y, n) is a red value of the pixel at the position (x, y) for the n^{th} image of coordinate (z); R(x−1, y, n) is a red value of the pixel at position (x−1, y) for the n^{th} image of coordinate (z); R(x, y−1, n) is a red value of the pixel at position (x, y−1) for the n^{th} image of coordinate (z); R(x+1, y, n) is a red value of the pixel at position (x+1, y) for the n^{th} image of coordinate (z); R(x, y+1, n) is a red value of the pixel at position (x, y+1) for the n^{th} image of coordinate (z).

5. The method of claim 3, wherein each third dimension coordinate (z) is selected using the equation:
Z(x, y)=Max(Pixel(x, y, 1), Pixel(x, y, 2) . . . Pixel(x, y, n)),
wherein Pixel(x, y, n) is the sharpness of the pixel at the position (x, y) of the n^{th} image at coordinate (z).

6. An apparatus for generating a three-dimensional model of an object, comprising:
an imaging unit configured to obtain a plurality of two-dimensional images of the object at different object distances, wherein the images comprises a plurality of pixels;
a computing unit configured to assign two-dimensional coordinate (x, y) to each pixel and a third dimension coordinate (z) to each image corresponding to the respective object distance,
the computing unit further configured to compute a sharpness value for each pixel and compare the pixel sharpness values of each two-dimensional coordinate (x, y) across all the images to select the image with the highest sharpness value,
the computing unit further configured to generate a plurality of three-dimensional coordinate (x, y, z) by combining each two-dimensional coordinate (x, y) with the third dimension coordinate (z) of the selected image,
the computing unit further configured to generate the three-dimensional model according to the plurality of three-dimensional coordinate (x, y, z); and
a storage unit configured to store the images and the three-dimensional model.

7. The apparatus of claim 6, wherein the imaging apparatus includes adjustable settings to increase or decrease the object distance by a multiple of a unit of focus; or by predetermined distance units between the imaging apparatus and the object.

8. The apparatus of claim 6, wherein the computing unit comprises a sharpness computation sub-unit configured to compute the sharpness value of each of the pixels using an equation:
Pixel(x, y, n)=aR*(PixelR(x, y, n))+aG*(PixelG(x, y, n))+aB*(PixelB(x, y, n)),
wherein Pixel(x, y, n) is the sharpness of the pixel at position (x, y) for the n^{th} image of coordinate (z); PixelR(x, y, n) is a red aberration between the pixel and other surrounding pixels; PixelG(x, y, n) is a green aberration between the pixel and other surrounding pixels; PixelB(x, y, n) is a blue aberration between the pixel and other surrounding pixels; aR is a red weight parameter; aG is a green weight parameter; and aB is a blue weight parameter.

9. The apparatus of claim 8, wherein the sharpness computation sub-unit computes the PixelR(x, y, n) using an equation:
PixelR(x, y, n)=abs(R(x, y, n)−R(x−1, y, n))+abs(R(x, y, n)−R(x, y−1, n))+abs(R(x, y, n)−R(x+1, y, n))+abs(R(x, y, n)−R(x, y+1, n)),
wherein abs is an absolute value sign; R(x, y, n) is a red value of the pixel at position (x, y) for the n^{th} image of coordinate (z), R(x−1, y, n) is a red value of pixel at position (x−1, y) for the n^{th} image of coordinate (z), R(x, y−1, n) is a red value of pixel at position (x, y−1) for the n^{th} image of coordinate (z), R(x+1, y, n) is a red value of pixel at position (x+1, y) for the n^{th} image of coordinate (z), R(x, y+1, n) is a red value of pixel at position (x, y+1) for the n^{th} image of coordinate (z).

10. The apparatus of claim 8, wherein the computing unit further comprises a gathering unit configured to generate and gather the three-dimensional coordinate (x, y, z) by combining each two-dimensional coordinate (x, y) with the third dimension coordinate (z) selected using the equation:
Z(x, y)=Max(Pixel(x, y, 1), Pixel(x, y, 2) . . . Pixel(x, y, n)),
wherein Pixel(x, y, n) is the sharpness of the pixel at the position (x, y) of the n^{th} image at coordinate (z).
